(19) United States
(12) Patent Application Publication
(10) Pub. No.: US 2024/0188566 A1
(43) Pub. Date: Jun. 13, 2024

(54) Biocidal Composition and Method

(71) Applicant: ARXADA, LLC, Morristown, NJ (US)

(72) Inventors: Kevin Janak, Blauvelt, NY (US); Scott Brown, Atlanta, GA (US); Kathryn Neely, Alpharetta, GA (US)

(21) Appl. No.: 18/551,203

(22) PCT Filed: Mar. 18, 2022
(86) PCT No.: PCT/US2022/020952

§ 371 Date: Sep. 19, 2023

Related U.S. Application Data
(60) Provisional application No. 63/163,279, filed on Mar. 19, 2021.

(51) Int. Cl. A01N 43/80; A01N 25/04; A01N 47/44; A01P 1/00

(52) U.S. Cl. CPC A01N 43/80; A01N 25/04; A01N 47/44; A01P 1/00

(57) ABSTRACT

In general, the present disclosure relates to biocidal compositions comprising an isothiazolone biocidal active compound in combination with a guanidine enhancer. These compositions can demonstrate highly effective prevention of deterioration and decay that can be caused by microbial contamination using low concentrations a biocidal active compound. The guanidine enhancer may be crystallized around inert inorganic mineral.

### RELATED APPLICATION

The present application is based on and claims priority to U.S. Provisional Patent application Ser. No. 63/163279, filed on Mar. 19, 2021, which is incorporated herein by reference.

### BACKGROUND

Biocidal agents are used in many fields to control the growth of harmful microorganisms and to prevent deterioration and decay caused by microbial contamination, microbial slime deposits and biofilms. As used herein the term “biocide” is intended to include, but is not restricted to, bactericides and fungicides and/or algaecides, and “biocidal activity” refers to both, the elimination and the inhibition of growth of bacteria and fungi and/or algae.

Isothiazolones (4-isothiazolin-3-ones, terms used interchangeably herein) are highly effective biocides and widely used as broad-spectrum biocides in various industries. Two of the most widely used isothiazolone biocides are 5-chloro-2-methyl-4-isothiazolin-3-one (chloromethylisothiazolinone or CMIT) and 2-methyl-4-isothiazolin-3-one (methylisothiazolinone or MIT), which are also often used together in a 3:1 mixture (CMIT: MIT). However, MIT is allergenic and cytotoxic, and this has led to some concern over use of MIT. Due to the increased use of these isothiazolinone-based preservatives in recent years, an increase in reported incidences of contact allergy to mixtures of MIT and CMIT has been reported. The 4-isothiazolin-3-one derivative, 1,2-benzisothiazolin-3-one (BIT), exhibits a broad antimicrobial activity spectrum against bacteria, fungi, and yeast and also exhibits a high degree of chemical and thermal stability. However, amounts of up to five hundred (500) ppm are required for a reliable and quick biocidal activity. N-(n-butyl)-1,2-benzisothiazolin-3-one (BBIT) is another biocide widely used in polymers, metal cutting oils, paints, and coatings for antibacterial and antifungal properties, and usually requires an amount of one and a half (1.5) to two (2) ppm to affect an adequate resistance against common bacteria or fungi, such as Aspergillus niger.

To broaden the effectiveness of biocidal compositions, isothiazolones have also been combined with various other biocides. For example, biocidal compositions including a pyrithione and a 2-alkylisothiazolin-3-one have been widely used in the past. Zinc pyrithione (ZPT) is a broad-spectrum antibacterial and antifungal agent. Due to low solubility of ZPT in water (8 ppm at neutral pH), zinc pyrithione is suitable for use in outdoor paints and other products that provide protection against mildew and algae.

Regulatory restrictions on the use of isothiazolone biocidal actives are increasing, and the use of this class of compounds will have to be further reduced in the future. Similarly, the recent and potential regulations on pyrithione salts typically used for similar applications will also result in a decrease in available pyrithione-based biocidal compositions. Thus, it has become imperative to identify biocidal compositions that provide similar or improved performance, but without known drawbacks.

### SUMMARY

In general, the present disclosure is directed to a composition having biocidal properties that exhibits appropriate biocidal activity against microorganisms such as bacterial and/or fungi, and may be used to protect technical materials (e.g., paints, coatings, or surfaces) against deterioration and decay caused by contamination with these microorganisms. The biocidal composition can be incorporated into various products to protect against or mitigate microbial growth in the product. In this manner, example implementations of the disclosure can include biocidal compositions, biocidal products incorporating the biocidal compositions, and methods for protecting materials or portions of materials using such biocidal compositions.

For instance, one example aspect of the present disclosure can include a biocidal composition including a 4-isothiazolin-3-one biocidal active compound and a guanidine enhancer that is one or more of 1-cyanoguanidine, a salt of 1-cyanoguanidine, 2-cyanoguanidine, and a salt of 2-cyanoguanidine. Results have demonstrated that the addition of such example guanidine enhancers can produce an adjuvant effect that improves the efficacy of known biocidal active compounds, while demonstrating no significant biocidal activity alone. This surprising result can allow for the formulation of biocidal compositions that include lower amounts of the 3-isothizolin-3-one biocidal actives mitigating at least some of the environmental concerns associated with such products.

Another example aspect of the present disclosure can include a product incorporating the biocidal composition. For manufacturing and production, certain biocidal compositions may be formulated at higher concentrations than required for effective protection. Example products incorporating the biocidal compositions can include effective concentrations of the guanidine enhancer and/or the 4-iosthiazolin-3-one biocidal active compound to provide effective protection. Additionally, concentrations of the 3-isothiazolin-3-one biocidal active may be present at reduced concentrations such that the product would display limited environmental or other safety concerns.

Another example aspect of the present disclosure can include a method for forming a biocidal composition with the guanidine enhancer. The method can include dispersing an inert inorganic mineral and a cyanoguanidine, such as one or more of 1-cyanoguanidine, a salt of 1-cyanoguanidine, 2-cyanoguanidine, and a salt of 2-cyanoguanidine, in a liquid. The cyanoguanidine can crystallize around the inert inorganic mineral to form the guanidine enhancer. Thus, the guanidine enhancer can include a cyanoguanidine crystallized on an inert inorganic mineral.

One additional example aspect of the present disclosure can include a method for formulating a product incorporating the biocidal composition. These, along with other features and aspects of the present disclosure are discussed in greater detail below.

### BRIEF DESCRIPTION OF THE DRAWINGS

A full and enabling description of the present disclosure is set forth more particularly in the remainder of the specification, including reference to the accompanying figures, in which:

FIG. 1 illustrates an example biocidal composition that can be combined with a product to produce a biocidal product according to example implementations of the present disclosure.

Repeat use of reference characters in the present specification and drawings is intended to represent the same or analogous features or elements of the present invention.

### DETAILED DESCRIPTION

It is to be understood by one of ordinary skill in the art that the present disclosure is a description of exemplary embodiments only and is not intended as limiting the broader aspects of the present disclosure.

The present disclosure is generally directed to a composition having biocidal properties that exhibits appropriate biocidal activity against microorganisms and may be used to protect materials against deterioration and/or decay caused by contamination from such microorganisms. In an example embodiment, the biocidal composition can include at least one 4-isothiazolin-3-one biocidal active compound and at least one guanidine enhancer. In another example embodiment, the biocidal composition can be incorporated in a carrier to produce a biocidal product. For example, the biocidal product could include a fluid carrier (e.g., a liquid, suspension, emulsion, or other similar fluids) that can be mixed with the biocidal composition to incorporate an effective amount of the biocidal composition to produce the biocidal product. In a further example embodiment, the biocidal composition and/or the biocidal product may applied to or otherwise incorporated in a region of a material as a treatment to protect at least the region of the material from deterioration and/or decay.

For implementations according to the present disclosure, an example biocidal composition can include at least one isothizolin-3-one biocidal active compound and at least one guanidine enhancer having the structure of Compound I, Compound I having the formula: HR2N—(C═NHR3)—NR1H

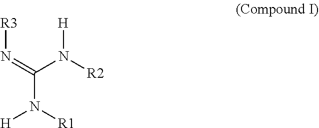

wherein, R3 is H, CN, C₁-C₃₀-alkyl, C₁-C₃₀-alkenyl, C₁-C₃₀-alkynyl, C₇-C₃₀-alkylaryl, or C₆-C₁₂-aryl; R1 is H, CN, C₁-C₃₀-alkyl, C₁-C₃₀-alkenyl, C₁-C₃₀-alkynyl, C₇-C₃₀-alkylaryl, or C₆-C₁₂-aryl; R2 is H, CN, C₁-C₃₀-alkyl, C₁-C₃₀-alkenyl, C₁-C₃₀-alkynyl, C₇-C₃₀-alkylaryl, or C₆-C₁₂-aryl; and wherein at least one of R3, R1, or R2 is CN.

As used herein, references to chemical formulas use standard element symbols according to the periodic table (e.g., C denotes carbon, N denotes nitrogen, etc.) Further, references to chemical formula are based on standard bonding such that carbon can make up to four (4) bonds and nitrogen can make up to three (3) bonds unless otherwise specified. As such, references to CN, should be understood as indicating a cyano group where carbon includes a triple bond with nitrogen and the remaining carbon bond can indicate attachment of the cyano group to a chemical structure.

In some implementations, the guanidine enhancer is one or more of the following: 1-cyanoguanidine, a salt of 1-cyanoguanidine, 2-cyanoguanidine (also referred to as dicyandiamide), and a salt of 2-cyanoguanidine. Both 1-cyanoguanidine and 2-cyanoguanidine are derivatives of Compound I, where R2 or R1 is CN and R3 is H, and R1 and R2 are H and R3 is CN, respectively. As should be understood, conversion between 1-cyanoguanidine and 2-cyanoguanidine may occur via tautomerization in aqueous solution or exposure to other proton donating solvents and so compositions that include only one tautomer, may display conversion over time to a mixture of both. Further, while exemplified using 1-cyanoguanidine and 2-cyanoguanidine, generally tautomer forms of species derived from Compound I can be included as guanidine enhancers in accordance with example implementations of the present disclosure. Tautomer forms of Compound I include structures (a) and (b), which have the formulas:

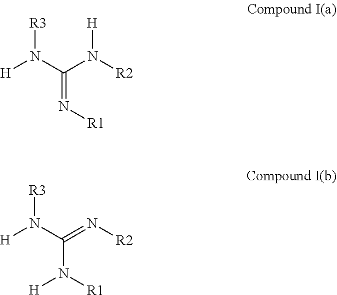

wherein, R3 is H, CN, C₁-C₃₀-alkyl, C₁-C₃₀-alkenyl, C₁-C₃₀-alkynyl, C₇-C₃₀-alkylaryl, or C₆-C₁₂-aryl; R1 is H, CN, C₁-C₃₀-alkyl, C₁-C₃₀-alkenyl, C₁-C₃₀-alkynyl, C₇-C₃₀-alkylaryl, or C₆-C₁₂-aryl; R2 is H, CN, C₁-C₃₀-alkyl, C₁-C₃₀-alkenyl, C₁-C₃₀-alkynyl, C₇-C₃₀-alkylaryl, or C₆-C₁₂-aryl; and wherein at least one of R3, R1, or R2 is CN.

In general, guanidine compounds can react with a proton donor to form a salt having a guanidinium cation carrying a positive charge, paired with an anion carrying a negative charge. Thus, in certain biocidal compositions, the guanidine enhancer can be a salt of Compound I such as a salt of 1-cyanoguanidine and/or a salt of 2-cyanoguanidine.

Some examples of anions that can be included as the salt of 1-cyanoguanidine or the salt of 2-cyanoguanidine can include inorganic anions such as a halide (e.g., chloride, bromide, fluoride, iodide, etc.), nitrate, sulfate, etc. Alternatively or additionally, the anion can include an organic anion such as acetate or carboxylate anions derived from fatty acids such as octanoic acid, decanoic acid, or dodecanoic acid.

In general, the at least one 4-isothiazolin-3-one biocidal active compound of the invention may be any 4-isothiazolin-3-one derivative known in the art that exhibits biocidal activity. For example, the at least one 4-isothiazolin-3-one biocidal active compound can be one or more of 1,2-benzisothiazolin-3-one (BIT), N-(n-butyl)-1,2-benzisothiazolin-3-one (BBIT), 5-chloro-2-methyl-2H-isothiazolin-3-one (CMIT), 2-methyl-2H-isothiazolin-3-one (MIT), 2-methyl-4,5-trimethylene-4-isothiazolin-3-one (MTI), 2-octyl-3(2H)-isothiazolone (OIT), dichloro-n-octyl-2H-isothiazolin-3-one (DCOIT), N-methyl-1,2-benzisothiazolin-3-one (nMBIT), and 2,2-dithiobis(N-methylbenzamide) (DTMB).

In certain implementations, the at least one 4-isothiazolin-3-one biocidal active compound is 1,2-benzisothiazolin-3-one (BIT), N-(n-butyl)-1,2-benzisothiazolin-3-one (BBIT), or a mixture thereof. In some implementations, BIT is the sole 4-isothiazolin-3-one biocidal active compound in the biocidal composition. Alternatively, for some implementations, BBIT is the sole 4-isothiazolin-3-one biocidal active compound in the biocidal composition. In addition to the at least one 4-isothiazolin-3-one biocidal active compound, biocidal compositions of the present disclosure can include at least one guanidine enhancer of Compound I.

The term “adjuvant” as used herein refers to an additive that can affect the performance of an active compound when used in combination with the active compound but does not exhibit any biocidal activity itself and/or does not exhibit significant biocidal activity itself in the compositions of the invention. While not being bound to any one particular theory, it is believed that the guanidine enhancer of the invention increases the biocidal efficacy of the biocidal active compounds by aiding in solubilizing these active compounds, or by acting as carrier for said active compounds. As a result, lower amounts of isothiazolone can be used in the biocidal composition of the invention to achieve desired biocidal activity, so that these biocidal compositions provide a robust protection and preservation of the product or locus to be protected from harmful bacteria and fungi.

In biocidal compositions according to the present disclosure, the relative amounts of the at least one 4-isothiazolin- 3-one biocidal active compound and the at least one guanidine enhancer may vary depending on, e.g., the nature of the biocidal active compound and the nature of the guanidine enhancer. Advantageously, however, the weight ratio of the guanidine enhancer to the 4-isothiazolin-3-one biocidal active compound is no greater than about 800:1 and no less than about 1:1, such as no greater than about 750:1 and no less than about 1:1, no greater than about 650: 1 and no less than about 25:1, no greater than about 580:1 and no less than 50:1, or no greater than about 400:1 and no less than 100:1. For some implementations, the weight ratio of the guanidine enhancer to the 4-isothiazolin-3-one biocidal active compound is no greater than about 800:1 and no less than about 500: 1 such as no greater than about 750:1 and no less than about 550:1 or no greater than about 700:1 and no less than about 600:1.

In particular, for example biocidal compositions, the weight ratio of the guanidine enhancer to the 4-isothiazolin-3-one biocidal active compound can be specified based on the total amounts of each 4-isothiazolin-3-one biocidal active compound, individual amounts of each 4-isothiazolin-3-one biocidal active compound, or both. As one example, for implementations that include two 4-isothiazolin-3-one biocidal active compounds (e.g., BIT and BBIT), the ratio of guanidine enhancer to 4-isothiazolin-3-one biocidal active compound may be specified for each 4-isothiazolin-3-one biocidal active compound. Additionally or alternatively, the ratio of guanidine enhancer to 4-isothiazolin-3-one biocidal active compound may be specified for the overall composition. For example, a biocidal composition according to the present disclosure can have a weight ratio of the guanidine enhancer to the 4-isothiazolin-3-one biocidal active compound that is no greater than about 800:1 and no less than about 500:1. The example biocidal composition can include a 4-isothiazolin-3-one biocidal active compound that is a mixture of BIT and BBIT and the ratio of BIT to the 4-isothiazolin-3-one biocidal active compound is no greater than about 650:1 and no less than about 25:1.

As used herein, the weight ratio of the guanidine enhancer to the 4-isothiazolin-3-one biocidal active compound should be read on the basis of the guanidine enhancer. As such no greater than about 800:1 is used to indicate that for every 1 weight units of the 4-isothiazolin-3-one biocidal active compound there is no greater than 800 weight units of guanidine enhancer. As another example for illustration, no less than about 1:1 is used to indicate that for every 1 weight units of the 4-isothiazolin-3-one biocidal active compound there is no less than 1 weight units of guanidine enhancer.

One example implementation according to the present disclosure can include a biocidal composition having a 4-isothiazolin-3-one biocidal active that is BIT, and a weight ratio of the guanidine enhancer to BIT no greater than about 800:1 and no less than about 1:1. In another example implementation, the biocidal composition can include a 4-isothiazolin-3-one biocidal active that is BIT and/or BBIT, and the weight ratio of the guanidine enhancer to BIT, BBIT, or both is no greater than about 800:1 and no less than about 1:1. In a still further example implementation, the biocidal composition can include a 4-isothiazolin-3-one biocidal active that is BIT and/or BBIT, and the weight ratio of the guanidine enhancer to BIT, BBIT or both is no greater than about 800:1 and no less than about 500:1.

In another example implementation, a biocidal composition can include a guanidine enhancer that is 1-cyanoguanidine and/or 2-cyanoguanidine and a 4-isothiazolin-3-one biocidal active compound that is BIT. For the biocidal composition, the weight ratio of the guanidine enhancer to BIT is no greater than about 800:1 and no less than about 1:1.

As another example implementation, a biocidal composition can include a guanidine enhancer that is 1-cyanoguanidine and/or 2-cyanoguanidine and a 4-isothiazoline-3-one biocidal active compound that is BBIT. For the example biocidal composition, the weight ratio of the guanidine enhancer to BBIT is no greater than about 800:1 and no less than about 1:1.

In a further example implementation, a biocidal composition can include a 4-isothiazolin-3-one biocidal active compound that is a mixture of BIT and BBIT and the guanidine enhancer is 1-cyanoguanidine and/or 2-cyanoguanidine. For the example biocidal composition, the weight ratio of 1-cyanoguanidine and/or 2-cyanoguanidine to BIT is no greater than about 400:1 and no less than about 1:1 and the weight ratio of 1-cyanoguanidine and/or 2-cyanoguanidine to BBIT is no greater than about 350:1 and no less than about 1:1.

As used herein, relative ratios or weight ratios refer to weight per weight (w/w) ratios. When a w/w ratio is disclosed herein for salts, such as guanidinium salts, it is calculated with respect to the free base, e.g., to the guanidinium moiety of a guanidinium salt. This means that the molecular weight of the counterion to the guanidinium cation is not taken into account when the relative ratio is calculated. Parts per million (ppm) as used herein, similarly refers to weight per weight ratios, i.e., one (1) ppm means 1×10⁻⁶, or 0.000001, or 0.0001% per weight.

The biocidal compositions of the invention are particularly effective against bacteria and/or fungi. Exemplary microorganisms can include one or more species from one or both of the following groups.

Bacteria: Alcaligenes such as Alcaligenes faecalis, Acinetobacter such as Acinetobacter calcoaceticus, Bacillus such as Bacillus subtilis, Citrobacter such as Citrobacter freundii, Corynebacterium such as Corynebacterium ammoniagenes, Enterobacter such as Enterobacter aerogenes or Enterobacter cloacae, Enterococcus such as Enterococcus hirae, Escherichia such as Escherichia coli, Proteus such as Proteus hauseri, Pseudomonas such as Pseudomonas aeruginosa, Pseudomonas fluorescens or Pseudomonas stutzeri, Salmonella such as Salmonella enterica, Staphylococcus such as Staphylococcus aureus;

Fungi: Acremonium such as Acremonium strictum, Alternaria such as Alternaria tenuis or Alternaria alternata, Aspergillus such as Aspergillus niger or Aspergillus brasiliensis, Candida such as Candida albicans, Chaetomium such as Chaetomium globosum, Fusarium such as Fusarium solani, Geotrichum such as Geotrichum candidum, Lentinus such as Lentinus tigrinus, Penicillium such as Penicillium glaucum, Penicillium funiculosum or Penicillium pinophilum, Rhodotorula such as Rhodotorula rubra or Rhodotorula mucilaginosa, Stachybotrys such as Stachybotrys chartarum, Trichoderma such as Trichoderma virens.

Biocidal compositions of the present disclosure may include further biocidal active compounds. Examples of such further biocidal active compounds are bronopol, benzyl hemiformal, tetramethylazodicarboxamide (TMAD), 1,3-bis(hydroxymethyl)-5,5-dimethylimidazolidine-2,4-dione (DMDMH), tris-hydroxymethyl nitromethane (THNM), dimethyl oxazolidine (DMO), p-chloro-m-cresol, dimethylol urea, 1,2-dibromo-2,4-dicyanobutane, 2,2-dibromo-3-nitrilopropionic acid amide, glutaric dialdehyde, ethylene glycol hemiformal, ethylenglykol-bis-hemiformal, N-methylol urea, bis(tetrakis hydroxymethyl) phosphonium sulfate (THPS), thiabendazol, carbendazim, zinc pyrithione, sodium pyrithione, potassium pyrithione, lithium pyrithione, ammonium pyrithione, calcium pyrithione, magnesium pyrithione, an organic amine pyrithione, barium pyrithione, strontium pyrithione, copper pyrithione, cadmium pyrithione, 2-phenoxyethanol, phenoxypropanol, o-phenyl-phenol, benzyl alcohol, sodium dithiocarbamates, chlorophen, quarternary ammonium salts, such as N-alkyl-N,N-dimethyl-benzyl-ammonium chloride, or tri-n-butyl tetradecyl phosponium chloride, C₈-C₁₆ alkyl amines, and organic acids such as benzoic acid, dehydroacetic acid, sorbic acid, salicylic acid.

However, for some implementations of the disclosure, the biocidal composition and/or biocidal product can be limited to only include a 4-isothiazolin-3-one biocidal active compound and no further biocidal active compounds such as those listed. In particular, example biocidal compositions of the disclosure can satisfy preservative efficacy requirements without employing pyrithione or pyrithione salts such as the ones listed above. For example, some implementations can include a biocidal composition that contains no pyrithione or pyrithione salts.

Further, in some implementations of the disclosure, the biocidal composition and/or biocidal product can be limited to not include a biguanidine or a polymeric biguanidine having a cyano group covalently bound to one or more of the nitrogens in the biguanidine or the polymeric biguanidine. For these compounds, without ascribing to one particular theory, the biguanidine or polymer may carry multiple positive charges and so may act as a disruptor to the cell membrane. Thus, these compounds may act as biocidal active compounds rather than adjuvants and their use in certain implementations of the disclosure may be limited.

In one example aspect, the biocidal composition and/or biocidal product with the guanidine enhancer can be formulated with one or more biocidal active compound, including at least one 4-isothiazolin-3-one biocidal active compound, in addition to the guanidine enhancer. As an example, the biocidal composition and/or biocidal product can be prepared by dispersing an inert inorganic mineral and dissolving the guanidine enhancer in a liquid. For instance, the guanidine enhancer may first be dissolved in the liquid, and the inert inorganic mineral may subsequently be dispersed in the liquid. Alternatively, the inert inorganic mineral may first be dispersed in the liquid, and the guanidine enhancer in a liquid may subsequently be dissolved in the liquid. The guanidine enhancer may then crystallize around the inert inorganic mineral to form the guanidine enhancer for the biocidal composition and/or biocidal product. Thus, the guanidine enhancer may be crystallized around inert inorganic mineral in certain example aspects.

The liquid may be any suitable liquid for dissolving the guanidine enhancer, such as one or more of the guanidine enhancer having the structure of Compound I. For example, the solvent may comprise water for dissolving 1-cyanoguanidine, a salt of 1-cyanoguanidine, 2-cyanoguanidine, and/or a salt of 2-cyanoguanidine. The liquid may be heated to assist with dissolving the guanidine enhancer. For example, the liquid may be heated to no less than fifty degrees Celsius (50° C.), no less than sixty degrees Celsius (60° C.), no less than seventy degrees Celsius (70° C.), no less than eighty degrees Celsius (80° C.), no less than ninety degrees Celsius (90° C.), or no less than one hundred degrees Celsius (100° C.) to assist with dissolving the guanidine enhancer. Heating the liquid may also assist crystallization of the guanidine enhancer around the inert inorganic mineral. For example, after dispersing the inert inorganic mineral and dissolving the guanidine enhancer and/or one or more biocidal active compound in the heated liquid, and the guanidine enhancer may crystallize around the inert inorganic mineral as the liquid cools. Thus, a temperature of the liquid may decrease as the guanidine enhancer crystallizes around the inert inorganic mineral.

The inert inorganic mineral may be a suitable material for dispersion within the liquid. For example, the inert inorganic mineral may be one or more of silicates, chalk, kieselguhr, calcium carbonate, magnesium carbonate, dolomite, magnesium oxide, calcium sulfate, clays, calcium bentonite, kaolin, Chinese clay, talc, perlite, mica, vermiculite, silica powder, montmorillonite, attapulgite, lime clay, loess, limestone, and lime. By dispersing the inert inorganic mineral within the liquid, the inert inorganic mineral may advantageously provide nucleation sites for crystallization of the guanidine enhancer.

The inert inorganic mineral may be selectively sized to provide a desirable particle size for the guanidine enhancer. For example, the inert inorganic mineral may be milled such that, after the guanidine enhancer crystallizes around the inert inorganic mineral, a particle size of the guanidine enhancer is about equal to a particle size of the one or more biocidal active compound, including at least one 4-isothiazolin-3-one biocidal active compound. Thus, both the particles of the guanidine enhancer and the particles of the one or more biocidal active compound, including at least one 4-isothiazolin-3-one biocidal active compound, dispersed in an aqueous dispersion may be about equal. As another example, the inert inorganic mineral may be milled such that, after the guanidine enhancer crystallizes around the inert inorganic mineral, a particle size of the guanidine enhancer facilitates dispersion of the guanidine enhancer in the biocidal composition and/or biocidal product with the guanidine enhancer. Controlling the milling size of the inert inorganic mineral may be advantageously more precise than milling of the guanidine enhancer.

The biocidal compositions of the invention have numerous applications and can be used in any suitable industry or field. The biocidal compositions of the invention may be in the form of a solution, an emulsion, a suspension, a dust, a powder, a foam, a paste, a granulate material, a resin or microencapsulated in polymeric materials. The formulation type depends on the particular intended purpose and should, in general, ensure a fine and uniform distribution of the biocidal composition according to the invention.

For instance, the biocidal compositions can be used in the paint and coating industry, the construction-chemistry field, the polymer-chemistry field, the mineral-oil industry, the textile industry or in the photochemical industry, etc. The degree of increase in biocidal activity seen for the biocidal active compound in the biocidal compositions of the invention also renders the biocidal compositions potentially useful as disinfectants. The biocidal compositions are particularly useful for in-can or dry-film preservation, or for the treatment of industrial process water.

More particularly, a biocidal composition of the present disclosure may include a solvent for distributing components of the biocidal composition. The solvent can act to distribute the components throughout the solvent such that any volume of solvent will have substantially equal concentrations of each component included in the biocidal composition (e.g., the guanidine enhancer). In one example implementation, the solvent can include water, though other solvents or mixtures of solvents known in the art may be incorporated in the biocidal composition.

In some implementations, the solvent may not appreciably dissolve all the components of the biocidal composition. For these compositions, a surfactant or other phase stabilizer may be used to produce a dispersion. For instance, some example implementations can include a biocidal composition that is an aqueous dispersion. The aqueous dispersion can be characterized by a water content based on the weight of the biocidal composition that is no greater than ninety-five percent (95%) percent and no less than twenty percent (20%). Thus, example implementations of the disclosure can include a biocidal composition that is an aqueous dispersion including a guanidine enhancer, and a 4-isothiazolin-3-one biocidal active compound.

The biocidal compositions of the invention may be added to a product or locus in or on which microorganisms are to be controlled. The biocidal active compound and the guanidine enhancer may be in the form of a concentrate including essential ingredients, i.e., the at least one 4-isothiazolin-3-one biocidal active compound and the at least one guanidine enhancer of Compound I (“biocidal concentrate”), which can then be added to said product. The concentrate may also be diluted with or suspended, dissolved or emulsified in a suitable solvent or carrier before being added to the product. The addition of the biocidal composition to the product to be protected can be used to produce a biocidal product.

Thus, the present disclosure further contemplates a biocidal product that includes a biocidal composition according to the disclosure.

In the biocidal product, the at least one 4-isothiazolin-3-one biocidal active compound and the at least one guanidine enhancer are present in a biocidal effective amount. The amounts of the at least one 4-isothiazolin-3-one biocidal active compound and of the at least one guanidine enhancer in the biocidal product can vary based on different factors, such as the biocidal active compound or the guanidine enhancer.

For example implementations of the biocidal product, the biocidal product can include an amount of the biocidal composition according to various implementations of the present disclosure so that the at least one 4-isothiazolin-3-one biocidal active compound is present in the biocidal product at a concentration no less than about one (1) ppm to no greater than about five hundred (500) ppm such as no greater than about four hundred (400) ppm, three hundred (300) ppm, two hundred (200) ppm, one hundred fifty (150) ppm, one hundred (100) ppm, fifty (50) ppm, or twenty five (25) ppm.

For example, the biocidal product can include a biocidal composition as provided in the present disclosure. The biocidal composition can include at least one 4-isothiazolin-3-one biocidal active compound that is BIT, BBIT or a mixture thereof. The BIT can be present in biocidal product at an amount no less than one (1) ppm and no greater than one hundred (100) ppm and/or the BBIT can be present in the biocidal product at an amount no less than about one (1) ppm and no greater than about one hundred thirty (130) ppm. For instance, the BBIT can be present in the biocidal product in an amount no less than about one (1) ppm and no greater than about one hundred thirty (130) ppm such as no greater than ninety (90) ppm, eighty (80) ppm, seventy (70) ppm or sixty (60) ppm (e.g., about ten (10) ppm, about twenty (20) ppm, about thirty (30) ppm, about forty (40) ppm, about fifty (50) ppm, etc.) Additionally or alternatively, the BIT can be present in the biocidal product in an amount no less than about ten (10) ppm and no greater than about one hundred thirty (130) ppm such as no less than about twenty (20) ppm and no greater than about one hundred twenty (120) ppm, no less than about thirty (30) ppm and no greater than about one hundred ten (110) ppm, no less than about forty (40) ppm and no greater than about one hundred (100) ppm, no less than about fifty (50) ppm and no greater than about one hundred (100) ppm, no less than about sixty (60) ppm and no greater than about one hundred (100) ppm, no less than about seventy (70) ppm and no greater than about one hundred (100) ppm, no less than about eighty (80) ppm and no greater than about one hundred (100) ppm, or no less than about ninety (90) ppm and no greater than about one hundred (100) ppm (e.g., about twenty five (25) ppm, about forty (40) ppm, about fifty (50) ppm, about sixty (60) ppm, about seventy (70) ppm, about eighty (80) ppm, about ninety (90) ppm, about one hundred (100) ppm or about one hundred ten (110) ppm).

More particularly, an example biocidal product may include a 4-isothiazolin-3-one biocidal active compound that is one or both of 1,2-benzisothiazolin-3-one and N-(n-butyl)-1,2-benzisothiazolin-3-one. The BIT can be present in the example biocidal product at an amount no less than twenty (20) ppm and no greater than sixty (60) ppm, the BBIT can be present in the example biocidal product at an amount no less than forty (40) ppm and no greater than one hundred (100) ppm, or both.

As should be understood, by adding the biocidal composition to the product to product the biocidal product, in general, the ratios of the at least one 4-isothiazolin-3-one biocidal active compound and of the at least one guanidine enhancer in the biocidal product are approximately the same as the ratios of these components in the biocidal composition according to the present disclosure.

Accordingly, the guanidine enhancer can be present in said biocidal product in an amount of from no less than about one (1) ppm and no greater than about forty thousand (40,000) ppm, such as no greater than about thirty eight thousand (38,000) ppm, about thirty six thousand (36,000) ppm, about thirty four thousand (34,000) ppm, about thirty two thousand (32,000) ppm, about thirty thousand (30,000) ppm, or about twenty five thousand (25,000) ppm (e.g., about fifteen thousand (15,000) ppm, about sixteen thousand (16,000) ppm, about eighteen thousand (18,000) ppm, about twenty thousand (20,000) ppm, about twenty two thousand (22,000) ppm, about twenty four thousand (24,000) ppm, about twenty six thousand (26,000) ppm, about twenty eight thousand (28,000 ppm), about thirty thousand (30,000) ppm, about thirty two thousand (32,000) ppm, about thirty four thousand (34,000) ppm, about thirty six thousand (36,000) ppm, about thirty seven thousand (37,000) ppm, about thirty eight thousand (38,000) ppm, about thirty nine thousand (39,000) ppm, about thirty nine thousand five hundred (39,500) ppm, about thirty nine thousand six hundred (39,600) ppm, about thirty nine thousand seven hundred (39,700) ppm or about thirty nine thousand eight hundred (39,800 ppm)).

In particular, an example biocidal product can include a 4-isothiazolin-3-one biocidal active compound that is 1,2-benzisothiazolin-3-one and the 1,2-benzisothiazolin-3-one is present in the product in an amount no less than ten (10) parts per million and no greater than ninety (90) parts per million. The example biocidal product can also include a guanidine enhancer that is 1-cyanoguanidine, 2-cyanoguanidine, or a mixture thereof, and the guanidine enhancer is present in the product in an amount no less than five hundred (500) ppm and no greater than seven thousand (7,000) ppm.

In one example implementation, the biocidal product can include the biocidal composition incorporated in a product, such as one or more of the following products, a paint, a coating, a sealant, a plaster, a starch solution, an aqueous mineral slurry, a dispersion, a caulk, a slurry of colored pigments, a slurry of inorganic fillers and colored pigments, a construction-chemical product, a glue or adhesive, a polymer dispersion, an emulsion polymer, a detergent or cleaner, a mineral oil or mineral oil product, a cooling lubricant, an auxiliary for leather and/or textile and/or photochemical industry, a pre-product or intermediate of the chemical industry, a wax and/or clay emulsion, an ink, a wash and a disinfectant.

Biocidal compositions of the invention may demonstrate improved biocidal efficacy in aqueous solvent systems. Accordingly, one aspect of example implementations can include a pH of the biocidal compositions or of the biocidal products.

The pH of the biocidal compositions or of the biocidal products of the invention may vary over a considerable range. Preferably, the pH of the biocidal compositions as well as of the biocidal products of the invention is above about five (5.0), about five and one half (5.5), about six (6.0), about six and one half (6.5), about seven (7.0), about seven and one half (7.5), about eight (8.0), or about eight and one half (8.5). More preferably, the pH is above about seven (7.0), about seven and one half (7.5), about eight (8.0), or about eight and one half (8.5). Most preferably, the pH is above about eight and one half (8.5) and below twelve (12.0). In certain implementations, the biocidal compositions or biocidal products can include a buffering agent. Examples of suitable buffering agents are known in the art. Generally, increased hydrolysis (i.e. reduced chemical stability) of the guanidine enhancers of the invention is observed under acidic conditions (i.e. a pH below about seven (7.0)).

Another example implementation of the present disclosure can include a method for inhibiting the growth of bacteria and fungi in a locus that may be subject or susceptible to contamination by bacteria and fungi. As one example, the method can include incorporating into or onto the locus a biocidal composition according to the present disclosure in an amount which is effective to adversely affect the growth of bacteria and fungi. Generally, the locus may be a place or locality, a surface, a material, a plant or a facility.

The preceding description is exemplary in nature and is not intended to limit the scope, applicability or configuration of the invention in any way. Various changes to the described embodiments may be made in the function and arrangement of the elements described herein without departing from the scope of the disclosure.

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used in this application and in the claims, the singular forms “a,” “an,” and “the” include the plural forms unless the context clearly dictates otherwise. Additionally, the term “includes” means “comprises.” The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

Unless otherwise indicated, all numbers expressing quantities of ingredients, properties such as molecular weight, percentages, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” means by weight as a percentage of the total weight or relative to another component in the composition.

The phrase “effective amount” means an amount of a compound that promotes, improves, stimulates, or encourages a response to the particular condition or disorder or the particular symptom of the condition or disorder.

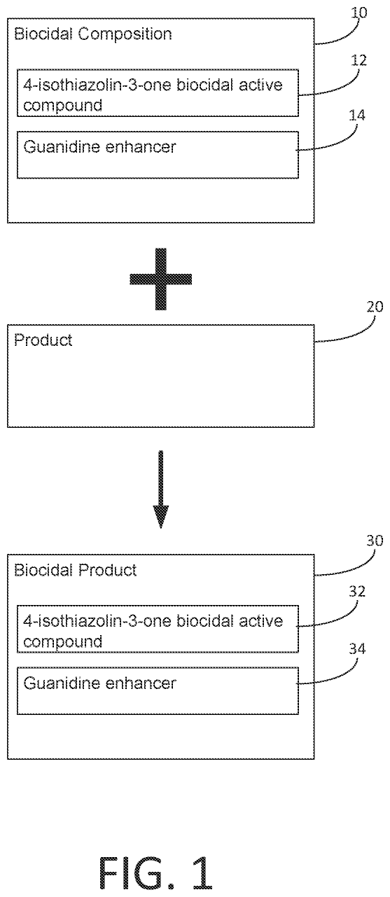

Referring now to the drawings, FIG. 1 illustrates several example aspects of the present disclosure. As shown, an example biocidal composition 10 can include a 4-isothiazolin-3-one biocidal active compound 12 and a guanidine enhancer 14. In some example implementations the biocidal composition 10 can be combined or otherwise incorporated with a product 20 (e.g., a paint, coating, or carrier) to produce a biocidal product 30. The biocidal product 30 can include an effective amount of the 4-isothiazolin-3-one biocidal active compound 12 and guanidine enhancer 14 according to example implementations of the present disclosure.

The present disclosure may be better understood with reference to the following example.

### EXAMPLE

Various formulations were made in accordance with the present disclosure and tested for performance. In one challenge test, the efficacy of dicyandiamide as an adjuvant for BIT was evaluated using modified ASTM D2574-97 “Standard Test Method for Resistance of Emulsion Paints in the Container to Attack by Microorganisms” with higher inoculation volumes and frequency. A standard consortium of four (4) bacterial populations: Pseudomonas aeruginosa, Escherichia coli, Enterobacter cloacae, Acinetobacter calcoaceticus was used to inoculate three (3) different samples at ten percent (10%), five percent (5%), or two and a half percent (2.5%) of the sample size. At twenty-four (24) hours and seventy-two (72) hours after each inoculation, a portion of each sample was streaked on tryptic soy agar. A dilution plate count was performed at the last seventy-two (72) hour time point. Results from this challenge are provided in Table 1.

TABLE 1
In-can challenge test to verify efficacy of dicyandiamide as adjuvant.

| | | Challenge 1 | | Challenge 2 | | Challenge 3 | |
|---|---|---|---|---|---|---|---|
| | Concentration | 10% | | 5% | | 2.5% | |
| Sample | (ppm) | 24 h | 72 h | 24 h | 72 h | 24 h | 72 h |
| Blank | 0 | 5c | 5c | NT | 5c | 5c | 3.8 × 10⁵ |
| BIT | 50 | 5 | 2 | NT | 5 | 5c | 7.8 × 10⁶ |
| | 100 | 5 | 0 | NT | 0 | 5 | 5.0 × 10¹ |
| Dicyandiamide | 5,000 | 5c | 5c | NT | 5c | 5c | 8.0 × 10⁶ |
| | 10,000 | 5c | 1 | NT | 5 | 5 | 4.2 × 10⁶ |
| Dicyandiamide + | 5,000 + 50 | 1 | 0 | NT | 0 | 2 | <10 |
| BIT | 5,000 + 100 | 0 | 0 | NT | 0 | 0 | <10 |

As shown in Table 1, the inclusion of dicyandiamide alone (not in combination with BIT) displayed no significant difference compared to the blank, which did not include dicyandiamide or a 4-isothiazolin-3-one biocidal active compound, such as BIT. However, the combination of dicyandiamide and BIT demonstrated a significant boost to the efficacy of BIT in the example challenge test. A repeat challenge test was performed using the same conditions to confirm efficacy and the results are summarized in Table 2.

TABLE 2
Repeat in-can challenge test to verify efficacy of dicyandiamide as adjuvant.

| | | Challenge 1 | | Challenge 2 | | Challenge 3 | |
|---|---|---|---|---|---|---|---|
| | Concentration | 10% | | 5% | | 2.5% | |
| Sample | (ppm) | 24 h | 72 h | 24 h | 72 h | 24 h | 72 h |
| Blank | 0 | 5c | 5c | NT | 5c | 5c | 1.0 × 10⁷ |
| BIT | 35 | 5c | 5c | NT | 5c | 5c | 3.0 × 10⁶ |
| | 50 | 5c | 5c | NT | 5c | 5c | 6.6 × 10⁶ |
| | 65 | 5c | 3 | NT | 5c | 5c | 1.0 × 10⁶ |
| | 75 | 5c | 0 | NT | 5 | 5c | 2.8 × 10⁵ |
| | 100 | 5c | 0 | NT | 5 | 5c | 1.8 × 10⁷ |
| Dicyandiamide | 5,000 | 5c | 5c | NT | 5c | 5c | 2.4 × 10⁷ |
| Dicyandiamide + | 5,000 + 65 | 5 | 0 | NT | 0 | 5 | <10 |
| BIT | 5,000 + 75 | 5 | 0 | NT | 0 | 5 | <10 |
| | 5,000 + 100 | 1 | 0 | NT | 0 | 5 | <10 |

A further challenge test was performed to evaluate the efficacy of dicyandiamide as an adjuvant for MIT as shown in Table 3.

TABLE 3
In-can challenge test to verify efficacy of dicyandiamide as adjuvant for MIT.

| | As Active (ppm) | | | | | | | |
|---|---|---|---|---|---|---|---|---|
| | | Dicyandiamide | 1^{st} | | 2^{nd} | | 3^{rd} | |
| Sample | MIT | (Dicy) | 24 | 72 | 24 | 72 | 24 | 72 |
| Negative Control | 0 | 0 | 5 | 5 | NT | 5 | 5 | 5 |
| Positive Control | NA | NA | 0 | 0 | NT | 0 | 0 | 0 |
| (2000 ppm Proxel BZ Plus)* | | | | | | | | |
| MIT − 50 30 ppm (15) | 15 | 0 | 5 | 5 | NT | 5 | 5 | 5 |
| MIT − 50 40 ppm (20) | 20 | 0 | 5 | 5 | NT | 5 | 5 | 5 |
| MIT − 50 50 ppm (25) | 25 | 0 | 5 | 2 | NT | 5 | 5 | 5 |
| MIT − 50 60 ppm (30)* | 30 | 0 | 5 | 0 | NT | 5 | 5 | 0 |
| MIT − 50 70 ppm (35)* | 35 | 0 | 5 | 0 | NT | 0 | 5 | 0 |
| MIT − 50 40 ppm (20) + | 20 | 3000 | 5 | 1 | NT | 5 | 5 | 5 |
| Dicy 3000 | | | | | | | | |
| MIT − 50 40 ppm (20) * + | 20 | 5000 | 5 | 0 | NT | 0 | 5 | 0 |
| Dicy 5000 | | | | | | | | |
| MIT − 50 50 ppm (25) + | 25 | 1500 | 5 | 0 | NT | 5 | 5 | 5 |
| Dicy 1500 | | | | | | | | |
| MIT − 50 50 ppm (25) * + | 25 | 3000 | 5 | 0 | NT | 0 | 5 | 0 |
| Dicy 3000 | | | | | | | | |
| MIT − 50 50 ppm (25) * + | 25 | 5000 | 5 | 0 | NT | 0 | 5 | 0 |
| Dicy 5000 | | | | | | | | |

As shown in Table 3, efficacy for samples containing MIT alone (e.g., using no guanidine enhancer such as dicyandiamide) display passing results (denoted by *) at 30 ppm or greater (e.g., 35 ppm). However, using a combination of MIT and dicyandiamide can allow for effective microbial control at MIT concentrations as low as 20 ppm. Additionally, higher concentrations of dicyandiamide appear to improve the efficacy of MIT, indicating that even lower concentrations of MIT (e.g., less than 20 ppm) may demonstrate effective microbial control depending on the concentration of dicyandiamide.

Example data provided in Tables 1, 2 and 3 should be understood as indicating the degree of microbial growth observed for a given data point unless otherwise indicated. In particular, each plate is ranked from 0 through 5c (i.e., one of 0, 1, 2, 3, 4, 5, or 5c) according to the degree of observed microbial growth, where: a “0” ranking indicates no growth; a “1” ranking indicates one (1) through five (5) observed colony forming unit (cfu), i.e., the plate was very lightly contaminated; a “2” ranking indicates six (6) through fifteen (15) cfu, i.e., the plate was lightly contaminated; a “3” ranking indicates sixteen (16) through thirty (30) cfu, i.e., the plate was moderately contaminated; a “4” ranking indicates thirty-one (31) through forty-five (45) cfu, i.e., the plate was heavily contaminated; a “5” ranking indicates greater than (45) cfu, i.e., the plate was severely contaminated; and a “5c” ranking indicates confluent growth, i.e., the plate was very severely contaminated. Thus, for instance, Table 1, Challenge 1 at 24 h for BIT 50 ppm has a value of 5 indicating greater than forty-five (45) cfu were observed. As another example for illustration, Table 1, Challenge 1 at 24 h for dicyandiamide 5,000 ppm+BIT 50 ppm has a value of 1 indicating one (1) through five (5) cfu was observed.

These and other modifications and variations to the present disclosure may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A method for forming a biocidal composition, comprising:
dispersing an inert inorganic mineral in a liquid;
dissolving a guanidine enhancer in the liquid; and
crystalizing the guanidine enhancer around the inert inorganic mineral,
wherein the guanidine enhancer is one or more of 1-cyanoguanidine, a salt of 1-cyanoguanidine, 2-cyanoguanidine, and a salt of 2-cyanoguanidine.

2. The method of claim 1, wherein the liquid comprises water.

3. The method of claim 1, wherein the liquid is heated to no less than seventy degrees Celsius prior to crystalizing the guanidine enhancer around the inert inorganic mineral.

4. The method of claim 1, wherein the liquid is heated to no less than eighty degrees Celsius prior to crystalizing the guanidine enhancer around the inert inorganic mineral.

5. The method of claim 1, wherein a temperature of the liquid decreases while the guanidine enhancer crystalizes around the inert inorganic mineral.

6. The method of claim 1, wherein the inert inorganic mineral comprises one or more of a silicate, chalk, kieselguhr, calcium carbonate, magnesium carbonate, dolomite, magnesium oxide, calcium sulfate, calcium bentonite, kaolin, Chinese clay, talc, perlite, mica, vermiculite, silica powder, montmorillonite, attapulgite, lime clay, loess, limestone, and lime.

7. The method of claim 1, wherein the inert inorganic mineral is milled prior to dispersing the inert inorganic mineral in the liquid.

8. The method of claim 1, further comprising dispersing a 4-isothiazolin-3-one biocidal active compound in the liquid.

9. A biocidal composition, comprising:
a 4-isothiazolin-3-one biocidal active compound; and
a guanidine enhancer,
wherein the guanidine enhancer is one or more of 1-cyanoguanidine, a salt of 1-cyanoguanidine, 2-cyanoguanidine, and a salt of 2-cyanoguanidine, and
the guanidine enhancer is crystalized around an inert inorganic mineral.

10. The biocidal composition of claim 9, wherein the 4-isothiazolin-3-one biocidal active compound is one or both of 1,2-benzisothiazolin-3-one and N-(n-butyl)-1,2-benzisothiazolin-3-one.

11. The biocidal composition of claim 9, wherein a weight ratio of the guanidine enhancer to the 4-isothiazolin-3-one biocidal active compound in the biocidal composition is no greater than about 800:1 and no less than about 1:1.

12. The biocidal composition of claim 9, wherein the biocidal composition is an aqueous dispersion, and the aqueous dispersion has a water content no less than twenty percent and no greater than ninety-five percent by weight of the biocidal composition.

13. A product, comprising the biocidal composition of any one of claim 9.

14. The product of claim 13, wherein the 4-isothiazolin-3-one biocidal active compound is present in an amount no less than about one part per million and no greater than about four hundred parts per million.

15. The product of claim 13, wherein the guanidine enhancer is present in an amount no less than one parts per million and no greater than thirty-two thousand parts per million.

16. The product of claim 13, wherein the product is a paint, a coating, a sealant, a plaster, a starch solution, an aqueous mineral slurry, a dispersion, a caulk, a slurry of colored pigments, a slurry of inorganic fillers and colored pigments, a construction chemical product, a glue or adhesive, a polymer dispersion, an emulsion polymer, a detergent or cleaner, a mineral oil or mineral oil product, a cooling lubricant, an auxiliary for leather and/or textile and/or photochemical industry, a pre-product or intermediate of the chemical industry, a wax, a clay emulsion, an ink, or a disinfectant.

17. The product of claim 16, wherein the product is a paint, a coating, an emulsion polymer, or an aqueous mineral slurry.
